(19) United States
(12) Patent Application Publication
(10) Pub. No.: US 2026/0067707 A1
(43) Pub. Date: Mar. 5, 2026

(54) END-TO-END (E2E) NETWORK CAPACITY PLANNING METHODOLOGY IN A CELLULAR NETWORK

(71) Applicant: DISH Wireless L.L.C., Englewood, CO (US)

(72) Inventors: Ahmed Awwad Whdan, Centennial, CO (US); John Sabando, Aurora, CO (US); Alberto Lozada, Littleton, CO (US); Shradha Niranjan Desai, Denver, CO (US); Arnold Foronda Agcaoili, Littleton, CO (US); Satish Sharma, Englewood, CO (US)

(21) Appl. No.: 18/822,678

(22) Filed: Sep. 3, 2024

(51) Int. Cl. H04W 16/22; H04L 41/16; H04L 43/0882; H04L 47/127; H04W 28/02

(52) U.S. Cl. CPC H04W 16/22; H04L 41/16; H04L 43/0882; H04L 47/127; H04W 28/0268

(57) ABSTRACT

Technologies for end-to-end (E2E) network resource planning in a cellular network are described. One method include identifying a plurality of network elements in the cellular network; identifying a capacity metric associated with each network element of the plurality of network elements; determining a threshold criterion of the capacity metric for each network element of the plurality of network elements; and predicting a timepoint of a breakage associated with each network element of the plurality of network elements, wherein the breakage occurs responsive to a capacity metric satisfies a corresponding threshold criterion.

### BACKGROUND

Cellular networks are highly complex. One type of cellular network is a fifth generation (5G) new radio (NR) cellular networks. 5G NR cellular networks have the promise to provide higher throughput, lower latency, and higher availability compared with previous global wireless standards. However, some resources in a 5G NR cellular network cannot be utilized efficiently, which may compromise such promise.

### BRIEF DESCRIPTION OF THE DRAWINGS

The present disclosure is illustrated by way of example, and not by way of limitation, in the figures of the accompanying drawings.

FIG. 1 is a block diagram of a system implementing end-to-end (E2E) network resource planning in a cellular network according to at least one embodiment.

FIG. 2 is a block diagram of a system including E2E resource planning managers that implements E2E network resource planning in a cellular network according to at least one embodiment.

FIG. 3 is a flow diagrams of an example method of E2E network resource planning in a cellular network according to at least one embodiment.

FIG. 4 illustrates example E2E network resource planning in a cellular network according to at least one embodiment.

### DETAILED DESCRIPTION

Technologies for implementing E2E network resource planning in a telecommunications network, such as a cellular network (e.g., 5G wireless network, 6G wireless network) are described. The following description sets forth numerous specific details, such as examples of specific systems, components, methods, and so forth, in order to provide a good understanding of several embodiments of the present disclosure. It will be apparent to one skilled in the art, however, that at least some embodiments of the present disclosure may be practiced without these specific details. In other instances, well-known components or methods are not described in detail or presented in simple block diagram format to avoid obscuring the present disclosure unnecessarily. Thus, the specific details set forth are merely exemplary. Particular implementations may vary from these exemplary details and still be contemplated to be within the scope of the present disclosure.

Resources used by certain components of a cellular network can encounter break in end-to-end data transmission, which may result in an over provision of resources or under provision of resources compared to the demand of resources. The decentralized nature of network architecture demands a counter-aggregation planning mechanism to reassemble and interconnect the disparate components with an end-to-end perspective in order to forecast the bottlenecks.

Aspects and embodiments of the present disclosure address the above and other deficiencies by implementing end-to-end (E2E) network resource planning in a cellular network. E2E refers to data flow from an end user equipment (UE), through the cellular network, to another end use equipment (UE) (same or different UE). In some situations, E2E also applies to data flow from an end user equipment (UE), through the cellular network, to an application or function in the cloud, or the data flow from the application or function in the cloud, through the cellular network, to an end user equipment (UE). The E2E network resource planning provides planning for network resources used in the data flow of E2E such that no breakage of network element would occur. The network element refers to a functional entity using network resources in the cellular network.

Specifically, a component of the cellular network (e.g., E2E resource planning manager) may identify network elements in the cellular network. The network elements may be in radio access network (“base station”) and may include radio units (RUs), distributed units (DUs), control plane centralized units (CU-CPs), user plane centralized units (CU-UPs), sectors of a cell (e.g., each sector covering a certain degree a, B, etc.), and cell sites. The network elements may be in transport (i.e., data transmission interconnection) and may include interfaces (e.g., N1, N2, N3, N6, described below) and communication links (e.g., links for synchronization signal transmission). The network elements may be in core network and may include network functions (e.g., AMF, SMF, UPF, AUSF, UDM, PCF, NSSF, described below). The network elements in cloud-computing platform 279 may include cloud-native network functions (e.g., virtualized AMF, virtualized SMF, virtualized UPF, virtualized AUSF, virtualized UDM, virtualized PCF, virtualized NSSF, described below).

The component of the cellular network (e.g., E2E resource planning manager) may identify a capacity metric associated with each network element in the cellular network. The capacity metric may include a counter or a key performance indicator (KPI). In some implementations, the specific capacity metric is associated with a characterization of performance of the network element. For example, the capacity metric may characterize a type of traffic handled by the network element, a user service requirement associated with the network element, a quality of service (QoS) identifier associated with the network element, a key performance indicator (KPI) of an infrastructure resource of the cellular network associated with the network element, status of the network element, a counter of the number of the same-type network element, a counter of the number of another-type network element served by the network element, etc.

The component of the cellular network (e.g., E2E resource planning manager) may determine a threshold criterion of the capacity metric for each network element in the cellular network. For example, the component of the cellular network may determine the threshold criterion of the capacity metric using historical data or capacity limits of the network element.

The component of the cellular network (e.g., E2E resource planning manager) may predict a timepoint of a breakage associated with each network element, wherein the breakage occurs responsive to a capacity metric satisfies a corresponding threshold criterion. In some implementations, the timepoint of the breakage associated with each network element may be predicted according to historical data. In some implementations, the historical data may include traffic flow and utilization of each network element in the cellular network. In some implementations, the historical data may include subscriber number, traffic capacity, specific-type of data amount per subscriber per day, or average data usage per subscriber per day. In some implementations, the historical data may be specific to a time period. In some implementations, the historical data may include sales information associated with the subscribers. In some implementations, the timepoint of the breakage associated with each network element may be predicted using a machine learning model.

The component of the cellular network (e.g., E2E resource planning manager) may take an action regarding a predicted timepoint of the breakage, where the action may include adjusting, at the predicted timepoint, at least one of: a capacity of memory, a capacity of storage, a number of central processing unit (CPU), or a bandwidth of network interconnection, provided locally (e.g., physically) or in the cloud (e.g., in virtualization). As such, the breakage can be avoided by implementing E2E resource planning mechanism.

Aspects and embodiments of the present disclosure can identify, by implementing E2E resource planning mechanism, potential capacity problems early enough to plan budget and deployment, reducing any customer issues that result from high usage and oversubscription, preventing QoS degradation and customer dissatisfaction. Aspects and embodiments of the present disclosure can improve system performance and cost-efficiency by providing suitable network resources to the demand.

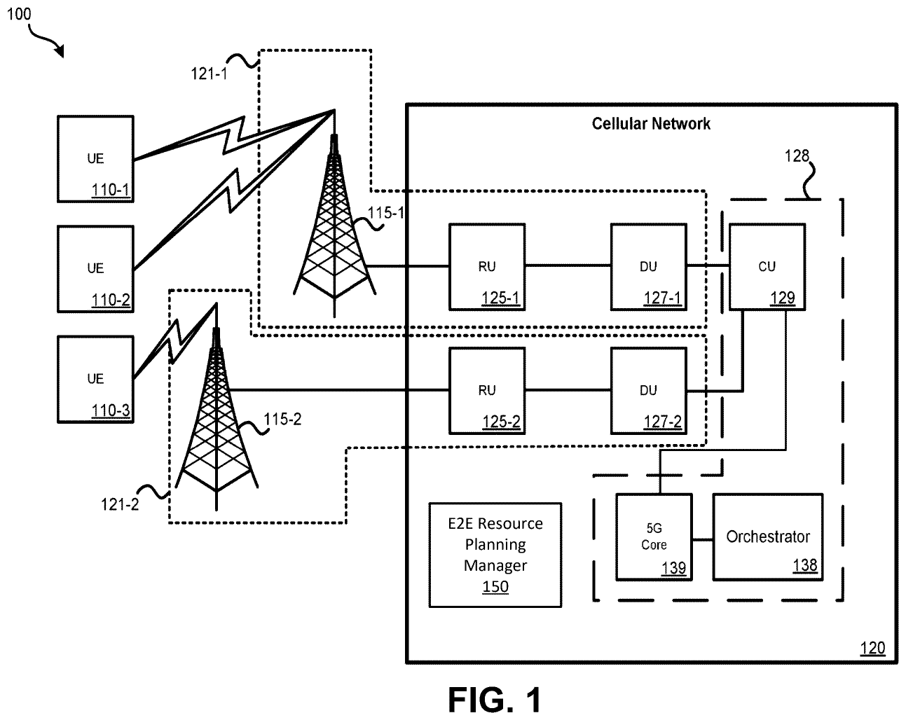

FIG. 1 illustrates an embodiment of a cellular network system 100 (“system 100”). FIG. 1 represents an embodiment of a cellular network which can accommodate the cloud-based architecture. System 100 can include a 5G New Radio (NR) cellular network; other types of cellular networks, such as 6G, 7G, etc. may also be possible. System 100 can include: UEs 110 (UE 110-1, UE 110-2, UE 110-3); base station 121; cellular network 120; radio units 125 (“RUs 125”); distributed units 127 (“DUs 127”); centralized unit 129 (“CU 129”); 5G core 139, and orchestrator 138. FIG. 1 represents a component-level view. In an open radio access network (O-RAN), because components can be implemented as specialized software executed on general-purpose hardware, except for components that need to receive and transmit radio frequency (RF), the functionality of the various components can be shifted among different servers. For at least some components, the hardware may be maintained by a separate cloud-service provider, to accommodate where the functionality of such components is needed.

UE 110 can represent various types of end-user devices, such as cellular phones, smartphones, cellular modems, cellular-enabled computerized devices, sensor devices, gaming devices, access points (APs), any computerized device capable of communicating via a cellular network, etc. Generally, UE can represent any type of device that has an incorporated 5G interface, such as a 5G modem. Examples can include sensor devices, Internet of Things (IoT) devices, manufacturing robots; unmanned aerial (or land-based) vehicles, network-connected vehicles, etc. Depending on the location of individual UEs, UE 110 may use RF to communicate with various base stations of cellular network 120. As illustrated, two base stations 121 are illustrated: base station 121-1 can include: structure 115-1, RU 125-1, and DU 127-1. Structure 115-1 may be any structure to which one or more antennas (not illustrated) of the base station are mounted. Structure 115-1 may be a dedicated cellular tower, a building, a water tower, or any other human-made or natural structure to which one or more antennas can reasonably be mounted to provide cellular coverage to a geographic area. Similarly, base station 121-2 can include: structure 115-2, RU 125-2, and DU 127-2.

Real-world implementations of system 100 can include many (e.g., thousands) of base stations (BSs) and many CUs and 5G core 139. Structures 115 can include one or more antennas that allow RUs 125 to communicate wirelessly with UEs 110. RUs 125 can represent an edge of cellular network 120 where data is transitioned to wireless communication. The radio access technology (RAT) used by RU 125 may be 5G New Radio (NR), or some other RAT. The remainder of cellular network 120 may be based on an exclusive 5G architecture, a hybrid 4G/5G architecture, a 4G architecture, or some other cellular network architecture. Base station 121 equipment may include an RU (e.g., RU 125-1) and a DU (e.g., DU 127-1).

One or more RUs, such as RU 125-1, may communicate with DU 127-1. As an example, at a possible cell site, three RUs may be present, each connected with the same DU. Different RUs may be present for different portions of the spectrum. For instance, a first RU may operate on the spectrum in the citizens broadcast radio service (CBRS) band while a second RU may operate on a separate portion of the spectrum, such as, for example, band 71. One or more DUs, such as DU 127-1, may communicate with CU 129.

Collectively, an RU, DU, and CU create a gNodeB, which serves as the radio access network (RAN) of cellular network 120. CU 129 can communicate with 5G core 139. The specific architecture of cellular network 120 can vary by embodiment. Edge cloud server systems outside of cellular network 120 may communicate, either directly, via the Internet, or via some other network, with components of cellular network 120. For example, DU 127-1 may be able to communicate with an edge cloud server system without routing data through CU 129 or 5G core 139. Other DUs may or may not have this capability.

While FIG. 1 illustrates various components of cellular network 120, other embodiments of cellular network 120 can vary the arrangement, communication paths, and specific components of cellular network 120. While RU 125 may include specialized radio access componentry to enable wireless communication with UE 110, other components of cellular network 120 may be implemented using either specialized hardware, specialized firmware, and/or specialized software executed on a general-purpose server system. In an O-RAN arrangement, specialized software on general-purpose hardware may be used to perform the functions of components such as DU 127, CU 129, and 5G core 139. Functionality of such components can be co-located or located at disparate physical server systems. For example, certain components of 5G core 139 may be co-located with components of CU 129.

In a possible virtualized O-RAN implementation, CU 129, 5G core 139, and/or orchestrator 138 can be implemented virtually as software being executed by general-purpose computing equipment, such as in a data center of a cloud-computing platform, as detailed herein. Therefore, depending on needs, the functionality of a CU, and/or 5G core may be implemented locally to each other and/or specific functions of any given component can be performed by physically separated server systems (e.g., at different server farms). For example, some functions of a CU may be located at a same server facility as where the DU is executed, while other functions are executed at a separate server system. In the illustrated embodiment of system 100A, cloud-based cellular network components 128 include CU 129, 5G core 139, and orchestrator 138. Such cloud-based cellular network components 128 may be executed as specialized software executed by underlying general-purpose computer servers. Cloud-based cellular network components 128 may be executed on a third-party cloud-based computing platform or a cloud-based computing platform operated by the same entity that operates the RAN. A cloud-based computing platform may have the ability to devote additional hardware resources to cloud-based cellular network components 128 or implement additional instances of such components when requested.

Kubernetes, or some other container orchestration platform, can be used to create and destroy the logical CU or 5G core units and subunits as needed for the cellular network 120 to function properly. Kubernetes allows for container deployment, scaling, and management. As an example, if cellular traffic increases substantially in a region, an additional logical CU or components of a CU may be deployed in a data center near where the traffic is occurring without any new hardware being deployed. (Rather, processing and storage capabilities of the data center would be devoted to the needed functions.) When the need for the logical CU or subcomponents of the CU no longer exists, Kubernetes can allow for removal of the logical CU. Kubernetes can also be used to control the flow of data (e.g., messages) and inject a flow of data to various components. This arrangement can allow for the modification of nominal behavior of various layers.

The deployment, scaling, and management of such virtualized components can be managed by orchestrator 138. Orchestrator 138 can represent various software processes executed by underlying computer hardware. Orchestrator 138 can monitor cellular network 120 and determine the amount and location at which cellular network functions should be deployed to meet or attempt to meet service level agreements (SLAs) across slices of the cellular network.

Orchestrator 138 can allow for the instantiation of new cloud-based components of cellular network 120. As an example, to instantiate a new core function, orchestrator 138 can perform a pipeline of calling the core function code from a software repository incorporated as part of, or separate from, cellular network 120; pulling corresponding configuration files (e.g., helm charts); creating Kubernetes nodes/pods; loading the related core function containers; configuring the core function; and activating other support functions (e.g., Prometheus, instances/connections to test tools).

A network slice functions as a virtual network operating on cellular network 120. Cellular network 120 is shared with some number of other network slices, such as hundreds or thousands of network slices. Communication bandwidth and computing resources of the underlying physical network can be reserved for individual network slices, thus allowing the individual network slices to reliably meet defined SLA parameters. By controlling the location and amount of computing and communication resources allocated to a network slice, the quality of service (QoS) and quality of experience (QoE) for UE can be varied on different slices. A network slice can be configured to provide sufficient resources for a particular application to be properly executed and delivered (e.g., gaming services, video services, voice services, location services, sensor reporting services, data services, etc.). However, resources are not infinite, so allocation of an excess of resources to a particular UE group and/or application may be desired to be avoided. Further, a cost may be attached to cellular slices: the greater the amount of resources dedicated, the greater the cost to the user; thus, optimization between performance and cost is desirable.

Particular network slices may only be reserved in particular geographic regions. For instance, a first set of network slices may be present at RU 125-1 and DU 127-1, a second set of network slices, which may only partially overlap or may be wholly different from the first set, may be reserved at RU 125-2 and DU 127-2.

Further, particular cellular network slices may include some number of defined layers. Each layer within a network slice may be used to define QoS parameters and other network configurations for particular types of data. For instance, high-priority data sent by a UE may be mapped to a layer having relatively higher QoS parameters and network configurations than lower-priority data sent by the UE that is mapped to a second layer having relatively less stringent QoS parameters and different network configurations.

Components such as DUs 127, CU 129, orchestrator 138, and 5G core 139 may include various software components that are required to communicate with each other, handle large volumes of data traffic, and are able to properly respond to changes in the network. In order to ensure not only the functionality and interoperability of such components, but also the ability to respond to changing network conditions and the ability to meet or perform above vendor specifications, significant testing must be performed.

5G core 139, which can be physically distributed across data centers or located at a central national data center (NDC), can perform various core functions of the cellular network. 5G core 139 can include: network resource management components; policy management components; subscriber management components; and packet control components. Individual components may communicate on a bus, thus allowing various components of 5G core 139 to communicate with each other directly. 5G core 139 is simplified to show some key components. Implementations can involve additional other components.

Network resource management components can include network repository function (NRF) and network slice selection function (NSSF). NRF can allow 5G network functions (NFs) to register and discover each other via a standards-based application programming interface (API). NSSF can be used by access and mobility management function (AMF) to assist with the selection of a network slice that will serve a particular UE.

Policy management components can include charging function (CHF) and policy control function (PCF). CHF allows charging services to be offered to authorized network functions. Converged online and offline charging can be supported. PCF allows for policy control functions and the related 5G signaling interfaces to be supported.

Subscriber management components can include unified data management (UDM) and authentication server function (AUSF). UDM can allow for generation of authentication vectors, user identification handling, NF registration management, and retrieval of UE individual subscription data for slice selection. AUSF performs authentication with UE.

Packet control components can include access and mobility management function (AMF) and session management function (SMF). AMF can receive connection- and session-related information from UE and is responsible for handling connection and mobility management tasks. SMF is responsible for interacting with the decoupled data plane, creating, updating, and removing protocol data unit (PDU) sessions, and managing session context with the user plane function (UPF) (e.g., manage UE context and network handovers between base stations).

User plane function (UPF) can be responsible for packet routing and forwarding, packet inspection, QoS handling, and external PDU sessions for interconnecting with a data network (DN) (e.g., the Internet) or various access networks. Access networks can include the RAN of cellular network 120.

The SMF may configure or control the UPF via the N4 interface. For example, the SMF may control packet forwarding rules used by the UPF and adjust QoS parameters for QoS enforcement of data flows (e.g., limiting available data rates). In some cases, multiple SMF/UPF pairs may be used to simultaneously manage user plane traffic for a particular user device, such as UE 210. For example, a set of SMFs may be associated with UE 210, where each SMF of the set of SMFs corresponds with a network slice. The SMF may control the UPF on a per end user data session basis, in which the SMF may create, update, and remove session information in the UPF. Decoupling control signaling in the control plane from user plane traffic in the user plane may allow the UPF to be positioned in close proximity to the edge of a network compared with the AMF. As a closer geographic or topographic proximity may reduce the electrical distance, the electrical distance from the UPF to the UE 210 may be less than the electrical distance of the AMF to the UE 210.

5G core 139 may reside on a cloud computing platform. While from a client's or user's point of view, the “cloud” can be envisioned as an ephemeral computing workspace that occupies no physical space, in reality, a cloud computing platform is an interconnected group of data centers throughout which computing and storage resources are spread. Therefore, data centers may be scattered geographically and can provide redundancy.

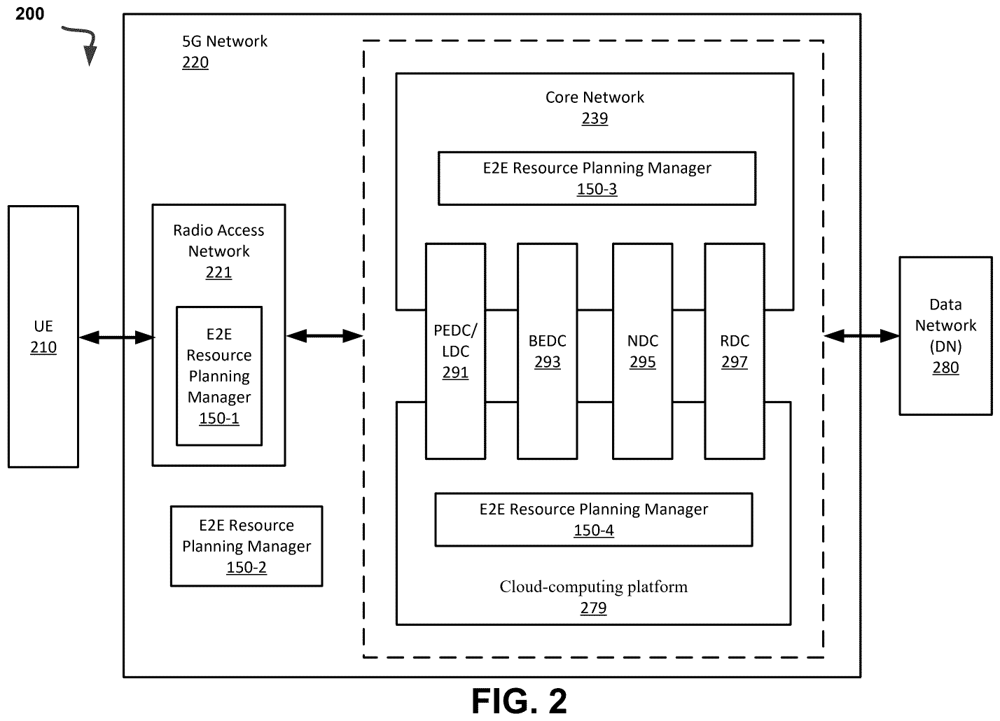

In some embodiments, the cellular network 120 includes an E2E resource planning manager 150 that implements E2E resource planning in a cellular network. In some embodiments, the E2E resource planning manager 150 is part of the base station(s). In some embodiments, the E2E resource planning manager 150 is part of the 5G core 139. Further details regarding the operations of the E2E resource planning manager 150 are described below with reference to FIGS. 2-6.

FIG. 2 is a block diagram of example E2E resource planning managers according to at least one embodiment. Referring to FIG. 2, a system 200 includes UE 210, a 5G network 220, and a data network (DN) 280 according to at least one embodiment. The 5G network 220 may include a radio access network (RAN) 221, a core network 239, and a cloud-computing platform 279. In at least one embodiment, an E2E resource planning manager (e.g., E2E resource planning manager 150-1) can be implemented in the RAN 221. In at least one embodiment, an E2E resource planning manager (e.g., E2E resource planning manager 150-2) can be implemented in the 5G network 220. In at least one embodiment, an E2E resource planning manager (e.g., E2E resource planning manager 150-3) can be implemented in the core network 239. In at least one embodiment, an E2E resource planning manager (e.g., E2E resource planning manager 150-4) can be implemented in the cloud-computing platform 279. In at least one embodiment, each of E2E resource planning managers 150-1, 150-2, 150-3, 150-4 can independently perform the operations described herein. In at least one embodiment, a combination of any of E2E resource planning managers 150-1, 150-2, 150-3, 150-4 can coordinately perform the operations described herein In at least one embodiment, E2E resource planning manager 150 described in FIG. 1 can be the same to one or more of E2E resource planning managers 150-1, 150-2, 150-3, 150-4.

Referring to FIG. 2, the 5G network 220 connects user equipment (UE) 210 to the data network (DN) 380, and the DN 380 can include the Internet, a local area network (LAN), a wide area network (WAN), a private data network, a wireless network, a wired network, or a combination of networks. The UE 210 can include an electronic device with wireless connectivity or cellular communication capability, including mobile computing device such as a mobile phone or handheld computing device, and non-mobile computing device. In at least one example, the UE 210 can include a 5G smartphone or a 5G cellular device that connects to the RAN 221 via a wireless connection. The UE 210 can include one of a number of UEs not depicted that are in communication with the RAN 221. The UE 210 may include mobile and non-mobile computing devices. The UE 210 may include laptop computers, desktop computers, an Internet-of-Things (IoT) devices, and/or any other electronic computing device that includes a wireless communications interface to access the RAN 221.

The RAN 221 includes a remote radio unit (RRU) for wirelessly communicating with UE 210. The RRU can include a Radio Unit (RU) and may include one or more radio transceivers for wirelessly communicating with UE 210. The RRU may include circuitry for converting signals sent to and from an antenna of a Base Station into digital signals for transmission over packet networks. The RAN may correspond with a 5G radio Base Station that connects user equipment to the core network 239. The 5G radio Base Station may be referred to as a generation Node B, a “gNodeB,” or a “gNB.” A Base Station may refer to a network element that is responsible for the transmission and reception of radio signals in one or more cells to or from user equipment, such as UE 210. The RAN 221 can include a new-generation radio access network (NG-RAN) that uses the 5G NR interface. In some embodiments, the distributed unit (DU) and the centralized unit (CU) of the RAN 221 may be co-located with the RRU. In other embodiments, the DU and the RRU may be co-located at a cell site and the centralized unit (CU) may be located within a local data center (LDC). The DU can include a logical node configured to provide functions for the radio link control (RLC) layer, the medium access control (MAC) layer, and the physical layer (PHY) layers. The centralized unit (CU) can be partitioned into a CU user plane portion (CU-UP) and a CU control plane portion (CU-CP). The CU-CP may perform functions related to a control plane, such as connection setup, mobility, and security. The CU-UP may perform functions related to a user plane, such as user data transmission and reception functions. In one example, the centralized units (CUs) can include a logical node configured to provide functions for the radio resource control (RRC) layer, the packet data convergence control (PDCP) layer, and the service data adaptation protocol (SDAP) layer. The centralized unit for the control plane (CU-CP) can include a logical node configured to provide functions of the control plane part of the RRC and PDCP. The centralized unit for the user plane (CU-UP) can include a logical node configured to provide functions of the user plane part of the SDAP and PDCP. In some embodiments, the RAN 221 may include virtualized CU units and virtualized DU units. The virtualized DU units can include virtualized versions of distributed units (DUs). The virtualized CU units can include virtualized versions of centralized units (CUs). Virtualizing the control plane and user plane functions allows the centralized units (CUs) to be consolidated in one or more data centers on RAN-based open interfaces.

In some embodiments, the RAN 221 may include a set of one or more remote radio units (RRUs) that includes radio transceivers (or combinations of radio transmitters and receivers) for wirelessly communicating with UEs. The set of RRUs may correspond with a network of cells (or coverage areas) that provide continuous or nearly continuous overlapping service to UEs, such as UE 210, over a geographic area. Some cells may correspond with stationary coverage areas and other cells may correspond with coverage areas that change over time (e.g., due to movement of a mobile RRU).

In some cases, the UE 210 may be capable of transmitting signals to and receiving signals from one or more RRUs within the network of cells over time. One or more cells may correspond with a cell site. The cells within the network of cells may be configured to facilitate communication between UE 210 and other UEs and/or between UE 210 and a data network. The cells may include macrocells (e.g., capable of reaching 18 miles) and small cells, such as microcells (e.g., capable of reaching 1.2 miles), picocells (e.g., capable of reaching 0.12 miles), and femtocells (e.g., capable of reaching 32 feet). Small cells may communicate through macrocells. Although the range of small cells may be limited, small cells may enable mmWave frequencies with high-speed connectivity to UEs within a short distance of the small cells. Macrocells may transit and receive radio signals using multiple-input multiple-output (MIMO) antennas that may be connected to a cell tower, an antenna mast, or a raised structure.

The core network 239 may utilize a cloud-native service-based architecture (SBA) in which different core network functions (e.g., authentication, security, session management, and core access and mobility functions) are virtualized and implemented as loosely coupled independent services that communicate with each other, for example, using hypertext transfer protocol (HTTP) protocols and APIs. In some cases, control plane (CP) functions may interact with each other using the service-based architecture. In at least one embodiment, a microservices-based architecture in which software is composed of small independent services that communicate over well-defined APIs may be used for implementing some of the core network functions. For example, control plane (CP) network functions for performing session management may be implemented as containerized applications or microservices. Although a microservice-based architecture does not necessarily require a container-based implementation, a container-based implementation may offer improved scalability and availability over other approaches. Network functions that have been implemented using microservices may store their state information using the unstructured data storage function (UDSF) that supports data storage for stateless network functions across the service-based architecture (SBA).

The core network 239 may include a set of network elements that are configured to offer various data and telecommunications services to subscribers or end users of user equipment, such as UE 210. Examples of network elements include network computers, network processors, networking hardware, networking equipment, routers, switches, hubs, bridges, radio network controllers, gateways, servers, virtualized network functions, and network functions virtualization infrastructure. A network element can include a real or virtualized component that provides wired or wireless communication network services.

The primary core network functions can include the access and mobility management function (AMF), the session management function (SMF), and the user plane function (UPF). The AMF may interface with UE 210, act as a single-entry point for a UE connection, and perform mobility management, registration management, and connection management between DN 380 and UE 210. The AMF may interface with the SMF to track user sessions. The AMF may interface with a network slice selection function (NSSF) to select network slice instances for user equipment. When user equipment is leaving a first coverage area and entering a second coverage area, the AMF may be responsible for coordinating the handoff between the coverage areas whether the coverage areas are associated with the same radio access network or different radio access networks. The SMF may perform session management, user plane selection, and Internet Protocol (IP) address allocation. After the Access Gateway Function (AGF) authenticates the subscriber and establishes a protocol data unit (PDU) session, the SMF may select the UPF for the subscriber.

The UPF may provide subscriber tunnel encapsulations enabled by the general packet radio service (GPRS) tunneling protocol, packet processing including routing and forwarding, quality of service (QoS) handling, packet data unit (PDU) session management, policy enforcement, statistics gathering and reporting, lawful intercept requests processing, and optional advanced services. The UPF may serve as an ingress and egress point for user plane traffic and provide anchored mobility support for user equipment. The UPF may be implemented as a software process or application running within a virtualized infrastructure or a cloud-based compute and storage infrastructure.

The UPF may transfer downlink data received from the DN 380 to the UE 210, via the RAN 221 and/or transfer uplink data received from the UE 210 to the DN 380 via the RAN 221. An uplink can include a radio link though which UE 210 transmits data and/or control signals to the RAN 221. A downlink can include a radio link through which the RAN 221 transmits data and/or control signals to the UE 210.

Uplink packets arriving from the RAN 221 may use a general packet radio service (GPRS) tunneling protocol (or GTP) to reach the UPF 232. The GPRS tunneling protocol for the user plane may support multiplexing of traffic from different PDU sessions by tunneling user data over the interface N3 between the RAN 221 and the UPF. The UPF may remove the packet headers belonging to the GTP tunnel before forwarding the user plane packets towards the DN 380. As the UPF may provide connectivity towards other data networks in addition to the DN 380, the UPF ensures that the user plane packets are forwarded towards the correct data network. Each GTP tunnel may belong to a specific PDU session. Each PDU session may be set up towards a specific data network name (DNN) that uniquely identifies the data network to which the user plane packets should be forwarded. The UPF may keep a record of the mapping between the GTP tunnel, the PDU session, and the DNN for the data network to which the user plane packets are directed.

Downlink packets arriving from the DN 380 are mapped onto a specific quality of service (QoS) flow belonging to a specific PDU session before forwarded towards the appropriate RAN 221. A QoS flow may correspond with a stream of data packets that have equal QoS. The PDU session may utilize one or more QoS flows to exchange traffic (e.g., data and voice traffic) between the UE 210 and the DN 380. The one or more QoS flows can include the finest granularity of QoS differentiation within the PDU session. The PDU session may belong to a network slice instance through the 5G network 220. To establish user plane connectivity from the UE 210 to the DN 380, the AMF 334 that supports the network slice instance may be selected and a PDU session via the network slice instance may be established. In some cases, the PDU session may be of type IPv4 or IPv6 for transporting IP packets. The RAN 221 may be configured to establish and release parts of the PDU session that cross the radio interface.

Other core network functions may include a network repository function (NRF) for maintaining a list of available network functions and providing network function service registration and discovery, a policy control function (PCF) for enforcing policy rules for control plane functions, an authentication server function (AUSF) for authenticating user equipment and handling authentication related functionality, a network slice selection function (NSSF) for selecting network slice instances, and an application function (AF) for providing application services. Application-level session information may be exchanged between the AF and PCF (e.g., bandwidth requirements for QoS). In some cases, when the UE 210 requests access to resources, such as establishing a PDU session or a QoS flow, the PCF may dynamically decide if the UE 210 should grant the requested access based on a location of the UE 210.

The 5G network 220 may provide one or more network slices, where each network slice may include a set of network functions that are selected to provide specific telecommunications services. For example, each network slice can include a configuration of network functions, network applications, and underlying cloud-based compute and storage infrastructure. In some cases, a network slice may correspond with a logical instantiation of a 5G network, such as an instantiation of the 5G network 220. In some cases, the 5G network 220 may support customized policy configuration and enforcement between network slices per service level agreements (SLAs) within the RAN 221. User equipment, such as UE 210, may connect to multiple network slices at the same time (e.g., eight different network slices). In some cases, the 5G network 220 may dynamically generate network slices to provide telecommunications services for various use cases, such the enhanced Mobile Broadband (eMBB), Ultra-Reliable and Low-Latency Communication (URLCC), and massive Machine Type Communication (mMTC) use cases.

A cloud-based compute and storage infrastructure can include a networked computing environment that provides a cloud computing environment. Cloud computing may refer to Internet-based computing, where shared resources, software, and/or information may be provided to one or more computing devices on-demand via the Internet (or other network). The term “cloud” may be used as a metaphor for the Internet, based on the cloud drawings used in computer networking diagrams to depict the Internet as an abstraction of the underlying infrastructure it represents.

Virtualization allows virtual hardware to be created and decoupled from the underlying physical hardware. One example of a virtualized component is a virtual router (or a vRouter). Another example of a virtualized component is a virtual machine. A virtual machine can include a software implementation of a physical machine. The virtual machine may include one or more virtual hardware devices, such as a virtual processor, a virtual memory, a virtual disk, or a virtual network interface card. The virtual machine may load and execute an operating system and applications from the virtual memory. The operating system and applications used by the virtual machine may be stored using the virtual disk. The virtual machine may be stored as a set of files including a virtual disk file for storing the contents of a virtual disk and a virtual machine configuration file for storing configuration settings for the virtual machine. The configuration settings may include the number of virtual processors (e.g., four virtual CPUs), the size of a virtual memory, and the size of a virtual disk (e.g., a 64 GB virtual disk) for the virtual machine. Another example of a virtualized component is a software container or an application container that encapsulates an application's environment. In some embodiments, applications and services may be run using virtual machines instead of containers in order to improve security. A common virtual machine may also be used to run applications and/or containers for a number of closely related network services.

The 5G network 220 may implement various network functions, such as the core network functions and radio access network functions, using a cloud-based compute and storage infrastructure. A network function may be implemented as a software instance running on hardware or as a virtualized network function. Virtual network functions (VNFs) can include implementations of network functions as software processes or applications. In at least one example, a virtual network function (VNF) may be implemented as a software process or application that is run using virtual machines (VMs) or application containers within the cloud-based compute and storage infrastructure. Application containers (or containers) allow applications to be bundled with their own libraries and configuration files, and then executed in isolation on a single operating system (OS) kernel. Application containerization may refer to an OS-level virtualization method that allows isolated applications to be run on a single host and access the same OS kernel. Containers may run on bare-metal systems, cloud instances, and virtual machines. Network functions virtualization may be used to virtualize network functions, for example, via virtual machines, containers, and/or virtual hardware that runs processor readable code or executable instructions stored in one or more computer-readable storage mediums (e.g., one or more data storage devices).

A logical hierarchical architecture may include National Data Centers (NDCs) 295, Regional Data Centers (RDCs) 297, and Breakout Edge Data Centers (BEDCs) 293. In addition, Passthrough Edge Data Centers (PEDC) 291 may serve as an aggregation point for all Local Data Centers (LDCs) 291 and cell sites in a given location.

The cloud computing platform 279 can be logically and physically divided up into various different cloud computing regions. Each of cloud computing regions can be isolated from other cloud computing regions to help provide fault tolerance and stability. Further, each of cloud computing regions may provide superior service to a particular geographic region based on physical proximity. For example, a first cloud computing region may have its datacenters and hardware located in the northeast of the United States while cloud computing region may have its datacenters and hardware located in California. Each of cloud computing regions may include two or more cloud computing sub-regions. Each of cloud computing subregions can allow for redundancy that allows for fail-over protection. Such as, if a particular cloud computing sub-region experiences an outage, another cloud computing sub-region within the same cloud computing region can continue functioning and providing service. For example, a database that is maintained as part of NDC 295 may be replicated in each cloud computing sub-region; therefore, if one of cloud computing sub-regions fail, a copy of the database remains up-to-date and available, thus allowing for continuous or near continuous functionality.

In the topology of a 5G NR cellular network, 5G core functions of core network 239 can logically reside as part of a national data center (NDC) 295. NDC 295 can be understood as having its functionality existing in multiple (e.g., two, three, or more) cloud computing sub-regions within cloud computing region. This arrangement allows for load-balancing, redundancy, and fail-over. Within NDC 295, multiple regional data centers (RDCs) can be logically present. Each of such one or more regional data centers may execute 5G core functions for a different geographic region or group of RAN components. As an example of 5G core components that can be executed within an RDC, such as RDC 297, may include UPFs, SMFs, and AMFs.

On a cloud-computing platform, processing capabilities can be divided up into virtualized processing instances. Each processing instance may be allocated up to a fixed amount of processing resources. Therefore, a processing instance can be thought of as a physical processor that has a maximum limit on the amount of processing it can perform over a given time. When a significant number of RDCs, NDCs, and cloud computing regions are considered as part of cloud computing platform 279, the number of functions executed across different NDC and RDC instances on cloud computing platform 279 can be high.

The E2E resource planning manager 150-1 may identify the network elements in RAN 221 for monitoring and planning, identify and measure the capacity metric associated with each network elements in RAN 221, determine a threshold criterion (e.g., value, range, etc.) of each capacity metric, and predict a timepoint of a breakage using historical data, where the breakage occurs when the capacity metric satisfies the corresponding threshold criterion.

The E2E resource planning manager 150-2 may identify the network elements in transport for monitoring and planning, identify and measure the capacity metric associated with each network elements in transport, determine a threshold criterion (e.g., value, range, etc.) of each capacity metric, and predict a timepoint of a breakage using historical data, where the breakage occurs when the capacity metric satisfies the corresponding threshold criterion. The transport refers to communication links and interfaces in the system 200.

The E2E resource planning manager 150-3 may identify the network elements in core network 239 for monitoring and planning, identify and measure the capacity metric associated with each network elements in core network 239, determine a threshold criterion (e.g., value, range, etc.) of each capacity metric, and predict a timepoint of a breakage using historical data, where the breakage occurs when the capacity metric satisfies the corresponding threshold criterion.

The E2E resource planning manager 150-4 may identify the network elements in cloud-computing platform 279 for monitoring and planning, identify and measure the capacity metric associated with each network elements in cloud-computing platform 279, determine a threshold criterion (e.g., value, range, etc.) of each capacity metric, and predict a timepoint of a breakage using historical data, where the breakage occurs when the capacity metric satisfies the corresponding threshold criterion.

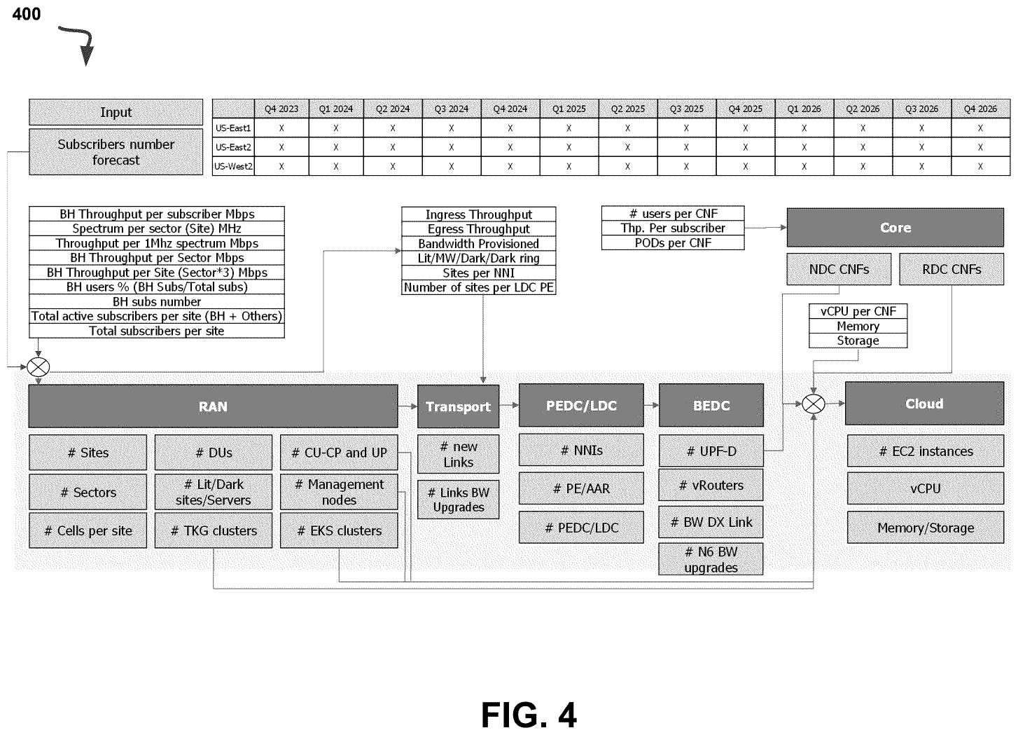

As such, each E2E resource planning manager may identify one or more network elements in the system 200 for monitoring and planning, identify and measure the capacity metric associated with each network elements in the system 200, determine a threshold criterion (e.g., value, range, etc.) of each capacity metric, and predict a timepoint of a breakage using historical data, where the breakage occurs when the capacity metric satisfies the corresponding threshold criterion. FIG. 4 illustrate an example of E2E network resource planning in a cellular network.

The network elements in RAN 221 may include RUs, DUs, CU-CPs, a CU-UPS, sectors of a cell (e.g., each sector covering a certain degree a, B, etc.), and cell sites. The network elements in transport may include interfaces (e.g., N1, N2, N3, N6, etc.) and communication links (e.g., links for synchronization signal transmission). The network elements in core network 239 may include network functions (e.g., AMF, SMF, UPF, AUSF, UDM, PCF, NSSF, etc.). The network elements in cloud-computing platform 279 may include cloud-native network functions (e.g., virtualized AMF, virtualized SMF, virtualized UPF, virtualized AUSF, virtualized UDM, virtualized PCF, virtualized NSSF, etc.).

The specific capacity metric is associated with a characterization of performance of the network element. For example, the capacity metric may characterize a type of traffic handled by the network element, a user service requirement associated with the network element, a quality of service (QoS) identifier associated with the network element, a key performance indicator (KPI) of an infrastructure resource of the cellular network associated with the network element, status of the network element, a counter of the number of the same-type network element, a counter of the number of another-type network element served by the network element, etc.

For example, a type of traffic handled by the network element may include the type of data traffic or voice traffic. The voice traffic may use less physical resource blocks (due to less data volume and processing requirement) than the data traffic. The latency requirement for the voice traffic and the data traffic may be different, for example, the data traffic may require a closer proximity in the data center of the cellular network with respect to the user equipment than that of the voice traffic. The time requirement for the voice traffic and the data traffic may be different, for example, the voice traffic needs to be handled immediately when it happens, whereas the data traffic may not need to be handled immediately and can be delivered in a delayed mode.

As another example, a user service requirement associated with the network element may include a type of user service agreement in the user's subscription, data demand of a user service, a business consideration of the user service, etc. The type of user service agreement in the user's subscription may include a standard user service agreement, a premium user service agreement, or other user service agreement. For example, the standard user service agreement may have less priority in request handling than a premium user service agreement. The data demand of the user service may include a prediction of data size at a specific time point, for example, based on historical data of the user service, and the user service may be based on type of services, such as static or dynamic, that network element is handling. The business consideration of the user service may consider the cost efficiency of the user service. For example, the business consideration of the user service may be represented by a scoring index, which can be assigned to each user's subscription or each user, and the associated revenue may be considered when assigning the scoring index.

As yet another example, a quality of service (QoS) identifier associated with the network element may be an indicator that represents the level of QoS. QoS is applied for each data stream all the way from the DN 280 through every core network on the data path to the US 210. The QoS flow is a logical pipeline defined for core network flow. The QoS identifier is one of the parameters of the QoS flow and may include parameters specifying one or more of: resource type (guaranteed bit rate (GBR), non-GBR, or delay critical GBR), default priority level, packet delay budget, packet error rate, default maximum data burst volume, default averaging window, etc.

As yet another example, a key performance indicator (KPI) of an infrastructure resource of the cellular network associated with the network element may include a measurement of the amount, the type, or the categories of radio resources consumed in processes performed by the network element. The examples of KPI may include peak data rates (e.g., downlink-20 gbps, uplink-10 gbps), peak spectral efficiency (e.g. downlink-30 bits/sec/Hz, uplink-15 bits/sec/Hz), data rate experience by user (e.g., downlink-100 mbps, uplink-50 mbps), area traffic capacity (e.g., downlink-10 Mbits/sec/m² in indoor hotspots), latency (user plane) (e.g., 4 ms for enhanced mobile broadband (eMBB), Ims for ultra-reliable low latency communications (URLLC)), connection density (e.g., 1 million devices/km²), average spectral efficiency (e.g., indoor hotspot—downlink 9/uplink 6.75, dense urban—downlink 7.8/uplink 5.4, rural—downlink 3.3/uplink 1.6), energy efficiency (such as efficient data transmission, low energy consumption) (e.g., 90% reduction in energy usage), reliability (e.g., 1 packet loss out of 100 million packets), mobility (e.g., dense urban-up to 30 kmph, rural-up to 500 kmph), mobility interruption time (e.g., 0 ms), system bandwidth (e.g., at least 100 MHz, up to 1 GHz for operation in high-frequency bands above 6 GHz). In at least one embodiment, the infrastructure resource is at least one of a dedicated transport resource in a backhaul link or a fronthaul link, a dedicated RF resource instance, customer RAN data, a transport slice pipeline, secure signaling session data, a RU, a RAN resource, or another service in the cellular network.

As yet another example, the status of network element may consider workload (e.g., data transaction) handled by network element, a capacity of network element, interference from other network elements, etc. The workload handled by the network element may be associated with time points or periods, geographic regions associated with data center, the number of UEs served by the network element and the state of each UE. The time points or periods may indicate the time point (e.g., workday day time such as every Monday 9 am, 12 am on the day of a holiday) or period of time (e.g., weekday 9 am to 5 pm, super bowl live time, holiday season, shopping season, sports season). The data center may include national data center (NDC), regional data center (RDC), and edge data centers (BEDC), and the design of data centers may be based on latency requirements and data processing considerations. The geographic regions associated with data center may indicate the expected demand for certain resources provided by the network element. The number of UEs may include the number of subscribers served by the network element. The number of UEs may include a (e.g., real-time) count of UE connected to the base stations provided by the network element. The state of UE may include movement of mobile UE. The state of UE may include the transaction mode of UE (e.g., idle mode or connected mode). The idle mode means that UE does not have a request to send or receive data to or from the base station or have the communication with the base station taking place. The connected mode means that UE has a request to send or receive data to or from the base station or has the communication with the base station taking place. The state of UE may include the proximity (e.g., measured by distance) to the base station. In one example, the status of network element may include the traffic in various interfaces. In another example, the status of network element may include a CU capacity (e.g., packets buffered in the CU), a DU capacity (e.g., packets buffered in the DU), traffic between DU and CU, current utilization including resource availability, user throughput, bearer service parameters, software package installed on each DU, etc. The user throughput is the number of correctly received bits by users delivered to upper layers over a certain period of time, divided by the channel bandwidth (e.g., measured in bits/s/Hz). Bearer Service is a service that allows transmission of information signals between network interfaces and gives the subscriber the capacity required to transmit appropriate signals between certain access points, i.e., user network interfaces. The parameters of bearer services include rate adapted sub-rate information like circuit switched asynchronous and synchronous duplex data (e.g., measured in bits), speech and data swapping during a call (e.g., selection of 3.1 kHz audio service).

As yet another example, a counter of the number of the same-type network element may include a counter of the number of RUs, a counter of the number of DUs, a counter of the number of CU-CPs, a counter of the number of DUs, a counter of the number of CU-UPs, a counter of the number of sectors, a counter of the number of cell sites, a counter of the number of new links, a counter of the number of network-to-network interfaces (NNIs), a counter of the number of data centers (e.g., PEDC/LDC), a counter of the number of AMFs, a counter of the number of UPFs, etc. As yet another example, a counter of the number of another-type network element served by the network element may include a counter of the number of DUs served by a CU, include a counter of the number of AMFs served by a SMF, etc.

The E2E resource planning manager 150 may determine a threshold criterion associated with each capacity metric. For example, the E2E resource planning manager 150 may determine threshold criterion as a threshold value, where a breakage occurs when the capacity metric reaches (or does not reach) or exceeds (or does not exceed) the threshold value. As another example, the E2E resource planning manager 150 may determine the threshold criterion as a threshold range, where a breakage occurs when the capacity metric falls in the threshold range. For example, a threshold criterion may be determined through analysis of historical data or may be determined by a capacity limit of the corresponding network resource. As such, the threshold criteria associated with each capacity metrics may form a comprehensive dimensioning rule to outline the capacity limits and to be utilized in resource planning mechanism.

The E2E resource planning manager 150 may predict a timepoint of a breakage associated with each network element, where the breakage occurs when the capacity metrics satisfies the corresponding threshold criterion. For example, the E2E resource planning manager 150 may compare the measured capacity metric to corresponding threshold criterion, and when the measured/predicted capacity metric satisfies the corresponding threshold criterion, the E2E resource planning manager 150 determines that a breakage associated with the network element occurs.

In some implementations, the threshold criterion may be satisfied using any of the combination of multiple capacity metric described above, in some cases, each with a respective weight factor. For example, the E2E resource planning manager 150 may compare a first measured/predicted capacity metric to a first threshold value Rn with a first weight factor (e.g., Rn multiplied by f1) and compare a second measured/predicted capacity metric to a second threshold value Mn with a second weight factor (e.g., Mn multiplied by f2), and when the first measured/predicted capacity metric exceeds Rn multiplied by f1 and the second measured/predicted capacity metric is below Mn multiplied by f2, the E2E resource planning manager 150 may determine that the threshold criterion is satisfied and the breakage associated with the network element occurs.

In some implementations, the timepoint of the breakage associated with each network element of the plurality of network elements is predicted using historical data. In some implementations, the historical data may include traffic flow and utilization of each network element in the cellular network. In some implementations, the historical data may include subscriber number, traffic capacity, specific-type of data amount per subscriber per day, or average data usage per subscriber per day. In some implementations, the historical data may be specific to a time period. In some implementations, the historical data may include sales information associated with the subscribers. In some implementations, the timepoint of the breakage associated with each network element of the plurality of network elements is predicted using a machine learning model. In some implementations, the E2E resource planning manager 150 may implement a tool to vary the data demand requested at UE (e.g., an end) to make the prediction.

In some implementations, the E2E resource planning manager 150 may predict a reference value of the capacity metric of the network element based on historical data. In some implementations, the E2E resource planning manager 150 may predict a reference value of the capacity metric for determination of the breakage of the capacity metric. In some implementations, the E2E resource planning manager 150 may retrieve historical data and use the historical data to predict a reference value of the capacity metric. In some implementations, the historical data may be specific to a capacity metric. In some implementations, the historical data may consider various capacity metrics in combination. In some implementations, the E2E resource planning manager 150 may predict a maximum value of the capacity metric to be used as a trigger of the breakage prediction. In some implementations, the E2E resource planning manager 150 may predict a minimum value of the resource parameter to be used such that the E2E resource planning manager 150 will not take an action that would affect the basic operation.

In some implementations the E2E resource planning manager 150 may take an action regarding a predicted timepoint of the breakage, wherein the action comprises adjusting at least one of: a capacity of memory, a capacity of storage, a number of CPU, or a bandwidth of network interconnection, provided locally (e.g., physically) or in the cloud (e.g., in virtualization). In some implementations, the E2E resource planning manager 150 may, according to the predicted timepoint, generate a value higher than a preset value of network resources used by the network element. In some implementations, the E2E resource planning manager 150 may, according to the predicted timepoint, generate a value lower than a preset value of network resources used by the network element. As such, the E2E resource planning manager 150 may increase or decrease the network resources that are in use at the predicted timepoint (e.g., a pre-defined incremental value of the of network resources) by the network element.

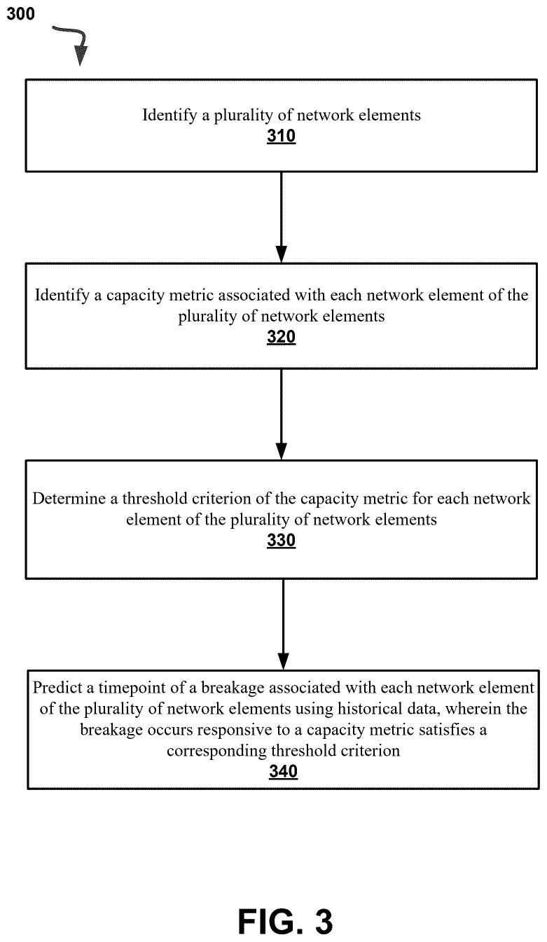

FIG. 3 is a flow diagram of a method 300 of implementing E2E network resource planning in a cellular network according to at least one embodiment. The method 300 may be performed by processing logic that may comprise hardware (e.g., circuitry, dedicated logic, programmable logic, microcode, etc.), software (e.g., instructions run on a processing device to perform hardware simulation), or a combination thereof. In one embodiment, the method 300 is performed by the system 100 of FIG. 1. In one embodiment, the method is performed by the E2E resource planning manager of FIGS. 1-2.

Referring to FIG. 3, at operation 310, the processing logic may identify a plurality network elements in the cellular network. In some implementations, the plurality of network elements comprise at least one of: a first set of network elements in one or more base stations, a second set of network elements in one or more transports, a third set of network elements in one or more core networks, or a fourth set of network elements in one or more cloud-computing platforms.

In some implementations, the first set of network elements in one or more base stations may include at least one of a RU, a DU, a CU-CP, a CU-UP, a sector, or a cell site. In some implementations, the second set of network elements in one or more transports may include at least one of: an interface, or a communication link. In some implementations, the third set of network elements in one or more core networks may include at least one network function. In some implementations, the fourth set of network elements in one or more cloud-computing platforms may include at least one cloud-native network function, where the cloud-native network function includes a software-implementation of a function or an application that runs in the cloud.

At operation 320, the processing logic may identify a capacity metric associated with each network element of the plurality of network elements. In some implementations, the capacity metric may include at least one of: a counter or a key performance indicator (KPI).

In some implementations, the capacity metric may characterize a type of traffic handled by the network element, a user service requirement associated with the network element, a quality of service (QoS) identifier associated with the network element, a key performance indicator (KPI) of an infrastructure resource of the cellular network associated with the network element, a status of the network element, a counter of the number of the same-type network element, or a counter of the number of another-type network element served by the network element. In some implementations, the type of traffic comprises at least one of: a type of data traffic or a type of voice traffic. In some implementations, the user service requirement comprises at least one of: a type of user service agreement in the user's subscription, data demand of a user service, or a business consideration of the user service. In some implementations, the quality of service (QoS) identifier comprises at least one parameter specifying one or more of: a resource type, a default priority level, a packet delay budget, a packet error rate, a default maximum data burst volume, or a default averaging window. In some implementations, the KPI comprises at least one parameter specifying one or more of: peak data rates, data rate experience by user, area traffic capacity, latency, connection density, average spectral efficiency, energy efficiency, reliability, mobility, mobility interruption time, or system bandwidth. In some implementations, the status of network element comprises at least one parameter specifying one or more of: workload handled by network element, a capacity of network element, or interference from other network elements.

At operation 330, the processing logic may determine a threshold criterion of the capacity metric for each network element of the plurality of network elements of the cellular network. In some implementations, the processing logic may determine the threshold criterion according to historical data. In some implementations, the processing logic may determine the threshold criterion according to capacity limits of network element.

At operation 340, the processing logic may predict a timepoint of a breakage associated with each network element of the plurality of network elements using historical data, wherein the breakage occurs responsive to a capacity metric satisfies a corresponding threshold criterion. In some implementations, the processing logic may predict the timepoint of the breakage using machine learning models or other artificial intelligence methods.

In some implementations, the processing logic may take an action regarding a predicted timepoint of the breakage, wherein the action comprises adjusting at least one of: a capacity of memory, a capacity of storage, a number of CPU, or a bandwidth of network interconnection, provided locally (e.g., physically) or in the cloud (e.g., in virtualization). In some implementations, the processing logic may, according to the predicted timepoint, generate a value higher than a preset value of network resources used by the network element. In some implementations, the processing logic may, according to the predicted timepoint, generate a value lower than a preset value of network resources used by the network element.

In some implementations, a system (e.g., system 100 in FIG. 1, system 200 in FIG. 2, or system 300 in FIG. 3) may include a computing system to facilitate a cellular network (e.g., the cellular network 120 in FIG. 1, or 5G network in FIG. 2), the computing system may include one or more processing devices and memory communicatively coupled with and readable by the one or more processing devices and having stored therein processor-readable instructions which, when executed by the one or more processing devices, cause the one or more processing devices to perform operations described herein.

The computing system may be a computing device such as a desktop computer, laptop computer, network server, mobile device, a vehicle (e.g., airplane, drone, train, automobile, or other conveyance), Internet of Things (IoT) enabled device, embedded computer (e.g., one included in a vehicle, industrial equipment, or a networked commercial device), or such computing device that includes memory and a processing device.

The processing device may represent one or more general-purpose processing devices such as a microprocessor, a central processing unit, or the like. More particularly, the processing device can be a complex instruction set computing (CISC) microprocessor, reduced instruction set computing (RISC) microprocessor, very long instruction word (VLIW) microprocessor, or a processor implementing other instruction sets, or processors implementing a combination of instruction sets. The processing device may also be one or more special-purpose processing devices such as an application specific integrated circuit (ASIC), a field programmable gate array (FPGA), a digital signal processor (DSP), network processor, or the like. Processing device may be configured to execute processor-readable instructions for performing the operations and steps discussed herein.

The memory may represent any combination of the different types of non-volatile memory devices (e.g., not-and (NAND) type flash memory and write-in-place memory, such as a three-dimensional cross-point (“3D cross-point”) memory device) and/or volatile memory devices (e.g., random access memory (RAM), such as dynamic random access memory (DRAM) and synchronous dynamic random access memory (SDRAM)). Examples of memory include a solid-state drive (SSD), a flash drive, a universal serial bus (USB) flash drive, an embedded Multi-Media Controller (eMMC) drive, a Universal Flash Storage (UFS) drive, a secure digital (SD) card, and a hard disk drive (HDD). Examples of memory further include a dual in-line memory module (DIMM), a small outline DIMM (SO-DIMM), and various types of non-volatile dual in-line memory modules (NVDIMMs).

In some implementations, a system (e.g., system 100 in FIG. 1 or system 200 in FIG. 2) may include one or more non-transitory, computer-readable storage media having computer-readable instructions thereon which, when executed by one or more processing devices, cause the one or more processing devices to perform operations described herein. The term “computer-readable storage medium” should be taken to include a single medium or multiple media that store the one or more sets of instructions. The term “computer-readable storage medium” shall also be taken to include any medium that is capable of storing or encoding a set of instructions for execution by the machine and that cause the machine to perform any one or more of the methodologies of the present disclosure. The term “computer-readable storage medium” shall accordingly be taken to include, but not be limited to, solid-state memories, optical media, and magnetic media. Processor-readable instructions or computer-readable instructions may include instructions to implement functionality corresponding to a E2E resource planning manager (e.g., the E2E resource planning manager 150 of FIGS. 1-2).

In the above description, numerous details are set forth. It will be apparent, however, to one of ordinary skill in the art having the benefit of this disclosure, that embodiments may be practiced without these specific details. In some instances, well-known structures and devices are shown in block diagram form rather than in detail in order to avoid obscuring the description.

Some portions of the detailed description are presented in terms of algorithms and symbolic representations of operations on data bits within a computer memory. These algorithmic descriptions and representations are the means used by those skilled in the data processing arts to convey the substance of their work most effectively to others skilled in the art. An algorithm is used herein and is generally conceived to be a self-consistent sequence of steps leading to the desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the above discussion, it is appreciated that throughout the description, discussions utilizing terms such as “determining,” “sending,” “receiving,” “scheduling,” or the like, refer to the actions and processes of a computer system, or similar electronic computing device, that manipulates and transforms data represented as physical (e.g., electronic) quantities within the computer system's registers and memories into other data similarly represented as physical quantities within the computer system memories or registers or other such information storage, transmission or display devices.

Embodiments also relate to an apparatus for performing the operations herein. This apparatus may be specially constructed for the required purposes, or it may comprise a general-purpose computer selectively activated or reconfigured by a computer program stored in the computer. Such a computer program may be stored in a computer-readable storage medium, such as, but not limited to, any type of disk including floppy disks, optical disks, Read-Only Memories (ROMs), compact disc ROMs (CD-ROMs), and magnetic-optical disks, Random Access Memories (RAMs), EPROMS, EEPROMs, magnetic or optical cards, or any type of media suitable for storing electronic instructions. One or more non-transitory, computer-readable storage media can have computer-readable instructions stored thereon which, when executed by one or more processing devices, cause the one or more processing devices to perform the operations described herein.

The algorithms and displays presented herein are not inherently related to any particular computer or other apparatus. Various general-purpose systems may be used with programs in accordance with the teachings herein, or it may prove convenient to construct a more specialized apparatus to perform the required method steps. The required structure for a variety of these systems will appear from the description below. In addition, the present embodiments are not described with reference to any particular programming language. It will be appreciated that a variety of programming languages may be used to implement the teachings of the present embodiments as described herein. It should also be noted that the terms “when” or the phrase “in response to,” as used herein, should be understood to indicate that there may be intervening time, intervening events, or both before the identified operation is performed.

It is to be understood that the above description is intended to be illustrative, and not restrictive. Many other embodiments will be apparent to those of skill in the art upon reading and understanding the above description. The scope of the present embodiments should, therefore, be determined with reference to the appended claims, along with the full scope of equivalents to which such claims are entitled.

What is claimed is:

1. A method of end-to-end (E2E) network resource planning in a cellular network, the method comprising:
identifying a plurality of network elements in the cellular network;
identifying a capacity metric associated with each network element of the plurality of network elements;
determining a threshold criterion of the capacity metric for each network element of the plurality of network elements; and
predicting a timepoint of a breakage associated with each network element of the plurality of network elements, wherein the breakage occurs responsive to a capacity metric satisfies a corresponding threshold criterion.

2. The method of claim 1, wherein the plurality of network elements comprise at least one of: a first set of network elements in one or more base stations, a second set of network elements in one or more transports, a third set of network elements in one or more core networks, or a fourth set of network elements in one or more cloud-computing platforms.

3. The method of claim 2, wherein the first set of network elements comprises at least one of: a radio unit (RU), a distributed unit (DU), a control plane centralized unit (CU-CP), a user plane centralized unit (CU-UP), a sector, or a cell site, wherein the second set of network elements comprises at least one of: an interface, or a communication link, wherein the third set of network elements comprises at least one network function, and wherein the fourth set of network elements comprises at least one cloud-native network function.

4. The method of claim 1, wherein the capacity metric comprises at least one of: a counter, or a key performance indicator (KPI).

5. The method of claim 1, wherein the threshold criterion of the capacity metric for each network element of the plurality of network elements is determined using historical data or one or more capacity limits of the network element.

6. The method of claim 1, wherein the timepoint of the breakage associated with each network element of the plurality of network elements is predicted according to historical data.

7. The method of claim 1, wherein the timepoint of the breakage associated with each network element of the plurality of network elements is predicted using a machine learning model.

8. The method of claim 1, further comprising:
taking an action regarding a predicted timepoint of the breakage, wherein the action comprises adjusting at least one of: a capacity of memory, a capacity of storage, a number of central processing unit (CPU), or a bandwidth of network interconnection.

9. A computing system to facilitate a cellular network, the computing system comprising:
one or more processing devices; and
memory communicatively coupled with and readable by the one or more processing devices and having stored therein processor-readable instructions which, when executed by the one or more processing devices, cause the one or more processing devices to perform operations comprising:
identifying a plurality of network elements in the cellular network;
identifying a capacity metric associated with each network element of the plurality of network elements;
determining a threshold criterion of the capacity metric for each network element of the plurality of network elements; and
predicting a timepoint of a breakage associated with each network element of the plurality of network elements, wherein the breakage occurs responsive to a capacity metric satisfies a corresponding threshold criterion.

10. The computing system of claim 9, wherein the plurality of network elements comprise at least one of: a first set of network elements in one or more base stations, a second set of network elements in one or more transports, a third set of network elements in one or more core networks, or a fourth set of network elements in one or more cloud-computing platforms.

11. The computing system of claim 10, wherein the first set of network elements comprises at least one of: a radio unit (RU), a distributed unit (DU), a control plane centralized unit (CU-CP), a user plane centralized unit (CU-UP), a sector, or a cell site, wherein the second set of network elements comprises at least one of: an interface, or a communication link, wherein the third set of network elements comprises at least one network function, and wherein the fourth set of network elements comprises at least one cloud-native network function.

12. The computing system of claim 9, wherein the capacity metric comprises at least one of: a counter, or a key performance indicator (KPI).

13. The computing system of claim 9, wherein the threshold criterion of the capacity metric for each network element of the plurality of network elements is determined using historical data or one or more capacity limits of the network element.

14. The computing system of claim 9, wherein the timepoint of the breakage associated with each network element of the plurality of network elements is predicted according to historical data.

15. The computing system of claim 9, wherein the timepoint of the breakage associated with each network element of the plurality of network elements is predicted using a machine learning model.

16. The computing system of claim 9, wherein the operations further comprise:
taking an action regarding a predicted timepoint of the breakage, wherein the action comprises adjusting at least one of: a capacity of memory, a capacity of storage, a number of central processing unit (CPU), or a bandwidth of network interconnection.

17. One or more non-transitory, computer-readable storage media having computer-readable instructions thereon which, when executed by one or more processing devices, cause the one or more processing devices to perform operations comprising:
identifying a plurality of network elements in a cellular network;
identifying a capacity metric associated with each network element of the plurality of network elements;
determining a threshold criterion of the capacity metric for each network element of the plurality of network elements; and
predicting a timepoint of a breakage associated with each network element of the plurality of network elements, wherein the breakage occurs responsive to a capacity metric satisfies a corresponding threshold criterion.

18. The one or more non-transitory, computer-readable storage media of claim 17, wherein the plurality of network elements comprise at least one of: a first set of network elements in one or more base stations, a second set of network elements in one or more transports, a third set of network elements in one or more core networks, or a fourth set of network elements in one or more cloud-computing platforms.

19. The one or more non-transitory, computer-readable storage media of claim 17, wherein the capacity metric comprises at least one of: a counter, or a key performance indicator (KPI).

20. The one or more non-transitory, computer-readable storage media of claim 17, wherein the timepoint of the breakage associated with each network element of the plurality of network elements is predicted according to historical data.
